(19) United States
(12) Patent Application Publication
(10) Pub. No.: US 2008/0292755 A1
(43) Pub. Date: Nov. 27, 2008

(54) Alkali Buffer + Minerals Supplement Additive

(76) Inventors: Lawrence M. Green, Pinecrest, FL (US); Sang Y. Whang, Miami, FL (US)

Correspondence Address: MERCHANT & GOULD PC, P.O. BOX 2903, MINNEAPOLIS, MN, 55402-0903, US

(21) Appl. No.: 12/126,785

(22) Filed: May 23, 2008

Related U.S. Application Data
(60) Provisional application No. 60/940,353, filed on May 25, 2007.

(51) Int. Cl. A23L 2/52

(52) U.S. Cl. 426/66

(57) ABSTRACT

The disclosure herein has applicability to a highly concentrated alkali buffers+minerals supplement solution is formed by combining potassium hydroxide (KOH) with sodium hydroxide (NaOH) with magnesium carbonate hydroxide (MgCO₃)₄, Mg(OH)₂.5H₂O and zinc (Zn) so that an alkali buffer of minerals blended into a supplement for adding to drinking water and other non-carbonated consumable drinks may be formulated. One part of concentrated alkali buffer+minerals supplements as the active ingredients for the additive solution of this invention is diluted with several parts of USP water into a one and one quarter ounce non-reactive bottle. The additive is further characterized by combining the active ingredients of potassium hydroxide with sodium hydroxide with magnesium carbonate hydroxide and zinc in a range of 7.6% potassium hydroxide and 1.9% sodium hydroxide and 0.3% magnesium carbonate hydroxide and 0.2% zinc as the active ingredients to 90% USP water (dilute with USP water) to fill a one and one quarter (1.25 oz)(37 ml) ounce, non-reactive bottle supplied with a droplet cap and screw-down cover cap in order to conveniently add the additive into an ordinary glass of drinking water in order to readily form a alkali buffer+minerals supplement for drinking water.

### FIELD OF THE DISCLOSURE

This invention relates to an alkali buffer+minerals supplement additive to achieve alkaline drinking water and deliver essential minerals to the body—a blend of active ingredients consisting of: potassium hydroxide with sodium hydroxide with magnesium carbonate hydroxide with zinc, added to USP water; a mixture for a alkali buffer+minerals supplement for healthy blood pH support, with essential minerals, bottled in a non-reactive bottle, delivered to the human body and animal body, to support an alkaline healthy blood range.

### FIELD OF THE INVENTION

The field of the present invention relates broadly to methods and solutions pertaining to health; “diet, evolution, aging and endogenous acid production. The pathophysiologic effects of the post-agricultural inversion of the potassium-to-sodium and base-to-chloride ratios in the human diet”. More specifically, the invention pertains to a source of a alkali buffer and minerals supplement additive for drinking water with essential minerals that is prepared and bottled in a non-reactive, easy to use, convenient, readily dispensable concentrated additive solution that is added to normal drinking water (8 to 10 oz glass) or to any consumable, non-carbonated drink;

Still more particularly, the invention relates to an additive of a concentrated alkali buffer and minerals supplement additive of a solution formed by the mixing of potassium hydroxide (KOH), sodium hydroxide (NaOH), magnesium carbonate hydroxide (MgCO₃)₄. Mg(OH)₂.5H₂ O and zinc (Zn) in amounts selected within a specific range. The additive solution is added to ordinary drinking water in order to increase the pill of the drinking water to a range of about 9.5 to 10.5.

Critical blood pH balancing in the alkaline range is indispensable when bicarbonate production is diminished or “endogenous acid production” (EAP)¹ is overwhelming and the body uses essential minerals from other sites where minerals consumption is normally consumed, yet sacrificed to compensate for pH swings caused by EAP or other factors. These swings could be represented hours or days or in mille second i.e. sudden cardiac death. Thus, relatively small alterations in plasma K concentrations can have major clinical manifestations. Since most intracellular K is found in muscle cells, potassium is found mostly in muscle tissue. Cardiac effects of hypokalemia are usually minimal until plasma K levels are <3 mEq/L. Hypokalemia may produce premature ventricular and atrial contractions, ventricular and atrial tachyarrhythmia's, and second or third degree atrioventricular block. The diagnosis of hypokalemia is made on the basis of plasma or serum K level <3.5 mEq/L. Occasionally renal tubular dysfunction or vigorous diuretic therapy may necessitate potassium supplementation. What is sudden cardiac death (SCD)? Sudden cardiac death (SCD), or cardiac arrest, is the sudden, abrupt loss of heart function in a person who may or may not have diagnosed heart disease. Sudden cardiac death is a major health problem, causing about 330,000 deaths each year among U.S. adults either before reaching a hospital oreemergency room. Heart medications. Under certain conditions, various heart medications can set the stage for arrhythmias that cause sudden cardiac death. In particular, so-called “antiarrhythmic” drugs, even at normally prescribed doses, sometimes may produce lethal ventricular arrhythmias (“proarrhythmic” effect). Regardless of whether there's organic heart disease, significant changes in blood levels, body levels of potassium and magnesium (from using diuretics, for example) also can cause life-threatening arrhythmias and cardiac arrest.

Magnesium (Mg) is the 4th most plentiful cation in the human body. The maintenance of plasma Mg concentration is largely a function of dietary intake and extremely effective renal and intestinal conservation. About 50% is sequestered in bone and is not readily exchangeable with other compartments⁴. As with Ca, protein binding of Mg is pH dependent. A wide variety of enzymes are Mg activated or dependent. Mg is required by all enzymatic processes involving ATP and is also required by many of the enzymes involved in nucleic acid metabolism. Mg is required for thiamine pyrophosphate cofactor activity and appears to stabilize the structure of macromolecules such as DNA and RNA. Mg is also related to Ca and K metabolism in an intimate but poorly understood way. Soluble in about 3300 parts CO2-free water; more soluble in water containing CO2; soluble in diluted acids with effervescence.

The added minerals zinc (Zn) present in the invention is an essential bioelement⁷, and a cofactor in many proteins. Zinc (Zn) is found mainly in bones, teeth, hair, skin, liver, muscle, leukocytes, and testes. Dietary intake of zinc by healthy adults varies from 6 to 15 mg/day, and absorption is about 20%. The signs and symptoms of zinc deficiency include anorexia, growth retardation, delayed sexual maturation, alopecia, immune disorders, dermatitis, night blindness, impaired taste and impaired wound healing and others.

### DESCRIPTION OF PRIOR ART

It is known that sodium is in every food and food product that is consumed by humans and others. That is and has been a reality for more than 300 hundred years and looking retrospectively it could be said that it is true for thousands of years. The average amount of sodium and potassium minerals in a 69.7 Kg (154 lb. adult man) is 63 grams and 150 grams, respectively. Since the atomic weights of sodium and potassium are 23 and 39 respectively, the ratio of the number of atoms to the average normal body amounts of these minerals, is 63/23 for sodium and 150/39 for potassium. These ratios translate into 41.6% sodium atoms to 58.4% potassium atoms. However, in today's average diet, unless one is conscientiously avoiding sodium, there are more floods that contain sodium than potassium. Diet, evolution and aging—the pathophysiologic effects of the post-agricultural inversion of the potassium-to sodium and base-to-chloride ratios in the human diet.

There is a device in a closely related field, an electrically powered water ionizer machine. Originally developed over sixty years ago in Japan, water ionizers have been successfully introduced in the United States within the last two decades or so. The chief purpose of these ionizer machines is to prepare alkaline drinking water from regular bottled or tap water. Accordingly, a ready demand for alkaline drinking water, recognized as being beneficial for some individuals, has developed in the health field.

Water ionizer machines do not add any minerals to, for example, regular tap water that is put into the machine. Instead, the ionizer has positive and negative electrodes that split the alkaline minerals in the tap water to one side for use and the water's acidic minerals to another side for discard. The pH in the final drinking water output from the machine, depending upon the minerals content of the water supplied to it, is an alkaline drinking water of increased oxygen that has a pH in the range of about 8.5 to about 10.5. Ionized water from such machines is essentially acid free because the ionization process removes the acid minerals from the machine's drinking water output. The acid water from such machines is discarded or finds use by florists for preserving cut flower shelf life. If the original water supplied to the ionizer is lacking alkaline minerals, the pH of the alkaline water produced may not reach the desired range.

Such water ionizers, although commercially successful, do suffer from several limitations. For example, these ionizer machines are expensive, ranging in price from about $600.00 to $2,000.00 each. In addition, such machines are relatively bulky, and thus are inconvenient for use by travelers. In addition, the convenience is somewhat in question since it does require a ready source of water, electricity and a discharge point for the acidic water.

In spite of their shortcomings, however, the aforementioned machines have clearly established a recognized demand for alkaline water. An increasing segment of the consuming public is now beginning to rely on a readily available supply of ionizer-produced alkaline water. What was not solved by such machines, however, was a simple, effective power-free way to convert ordinary tap or bottled water into alkaline water that is experiencing an increased consumer demand.

This invention overcomes the uninviting characteristics of the ionizer machines, and provides a simple, ready-to-use, concentrated additive that is easily added to bottled or tap water in order to convert regular potable water into a alkali buffer and minerals supplement for water to have a pH in the range of about 9.5 to 10.5 where ever you are. In use, four drops of the highly concentrated alkali buffer and minerals supplement solution of this invention, is added to a glass or container of regular drinking water, 8 to 10 oz. in order to change the water into alkaline water with a minerals supplements for consumable water of the desired pH range of 9 to 10.5.

### SUMMARY OF THE INVENTION

This invention provides a highly concentrated alkali buffer and minerals supplement solution that is formed by blending potassium hydroxide (KOH), sodium hydroxide (NaOH), magnesium carbonate hydroxide (MgCO₃)₄.Mg(OH)₂.5H₃O with zinc (Zn) to enhance bio-absorption. By using two or more different combinations of the zinc phosphates embodied in this invention, the pH can be further controlled in solution. More particularly, the invention combines one part of concentrated alkali buffer and minerals supplement additive solution diluted with nine parts of USP water packaged in one and one quarter (1.25 oz.) ounce non-reactive bottle. This invention, the alkali buffer and minerals supplement solution additive mixture is commercialized and sold by the assignee of this invention under the trade name of PHX™ Alkali Buffer+or et al.

The additive of this invention is further characterized by a diluted mixture of about one part additive to nine parts USP water wherein the active ingredients are formed by combining potassium hydroxide, sodium hydroxide, magnesium carbonate hydroxide, and zinc in a range of about 9.0% potassium hydroxide, 0.5% sodium hydroxide, 0.3% magnesium carbonate hydroxide and 0.2% zinc. This range is flexible to a+or minus 10% variable of the absolute values specified herein to meet certain conditions of the consumer that require this range to be altered+90% USP water to about 4.8% potassium hydroxide and about 4.7% sodium hydroxide, 0.3% magnesium carbonate hydroxide and 0.2% zinc. In one of the preferred embodiments, one and one quarter ounce (1.25 oz.) bottles of 4.8% potassium hydroxide to about 4.7% sodium hydroxide, 0.3% magnesium carbonate hydroxide and 0.2% zinc in the one to nine ratio—of USP water combined with—this range being flexible to a+or minus 10% variable of the absolute values specified herein to meet certain conditions of the consumer that require this range to be altered. More particularly, the invention combines one part of concentrated active ingredients diluted with nine parts of USP water packaged in one and one quarter (1.25 oz.) ounce non-reactive bottle.

Packaged in one and one quarter ounce, non-reactive bottle is supplied with a droplet cap in order to allow the user to conveniently measure the additive amount into an ordinary glass of drinking water 8 to 10 oz. The amount of USP water is simply to dilute the concentrated form of active ingredients into an easily manageable droplets form for addition to a glass of 8 to 10 oz. drinking water. Thus, if diluted by the ratio of one part concentrate to nineteen parts USP water, one must add twice as many drops to achieve the same pH value of an alkali buffer and minerals supplement for drinking water.

### OBJECT OF THE INVENTION

It is an object of the present invention to provide a more convenient source of a alkali buffer and minerals supplement additive for drinking water to increase pH value.

It is another object of this invention to provide a alkali buffer and minerals supplement for drinking water by use of an additive rather than relying upon a more complicated, not always accessible, and expensive water ionizer machine that requires electricity and drainage.

It is still another object of this invention to formulate a alkali buffer and minerals supplement for drinking water by use of an additive prepared from USP water in combination with selected amounts of potassium hydroxide, sodium hydroxide, magnesium carbonate hydroxide and zinc.

It is yet another object of this invention to increase yet lower-valued pH water with a alkali buffer and minerals supplement for water made by an ionizer to achieve a higher pH value by use of a small amount of alkali buffer and minerals supplement for additive to the ionizer water.

It is still a further object of this invention to provide a readily available, easily accessible, effective adjunct source for alkaline-minerals water when ionizer machine-produced alkaline water is not available.

It is yet another object of this invention to provide a readily available, easily accessible, effective alkali buffer and minerals supplement additive for consumers of other drinks, hot, cold or room temperature (not carbonated) that choose to make their drink more alkaline, raising the pH value.

### DESCRIPTION OF PREFERRED EXAMPLE EMBODIMENT AND BEST MODE OF THE INVENTION

Turning now to a detailed description of the invention, which may be understood without reference to any drawing, one must first understand that many minerals are present in ordinary drinking water. Such tap water naturally has a pH of about 7 or 8, and in its natural form, is not a alkali buffer and minerals supplement for—although some a alkali buffer and minerals supplement for minerals may be present.

The purpose of this invention is to supply an additive solution to purposely turn the 10 low pH of ordinary drinking water into an alkali buffer and minerals supplement for drinking water. Moreover, the invention will yield an alkali buffer and minerals supplement for drinking water having a pH of about 9.5 to 10.5. The alkali buffer and minerals supplement for water of this invention is not a medicine to treat or cure any disease. It does, however, neutralize excess body acids and helps the body dispose of such body acids. By so doing, the health of many people have improved in a natural way which is enhanced by an alkali buffer and minerals supplement for drinking water formulated in accordance with the buffer additive of this invention.

The predominant alkali buffer and minerals supplement for minerals found in ordinary drinking water are calcium and magnesium, not potassium or sodium. There is no known natural supply of drinking water where the predominant alkali buffer and minerals supplement for minerals is potassium. Therefore, the predominant alkali buffer and minerals supplement for minerals in high pH alkali buffer and minerals supplement for water, without employing the buffer additive of this invention, are generally considered to be calcium and magnesium. This invention, in contrast, is an alkali buffer and minerals supplement for water made by adding potassium hydroxide and sodium hydroxide, magnesium carbonate hydroxide and zinc to regular water.

A summary of the development of this invention is believed to be helpful to understanding the basis for the preferred embodiment of the alkali buffer and minerals supplement for buffer additive. Sodium hydroxide is commonly used to increase the alkalinity of any alkali. However, sodium (Na) alone is reportedly harmful to ones health and thus sodium free diets have been advocated. Calcium (Ca) and magnesium (Mg) hydroxide concentrations are very murky and do not dissolve easily in water. For these reasons these alternatives were not deemed acceptable in a search for a convenient alkali buffer and minerals supplement for concentrate.

In the human body, it is important to maintain a proper balance of potassium and sodium. A prolonged use of potassium hydroxide alone may cause an imbalance of potassium and sodium. For this reason, a combination of potassium hydroxide and sodium hydroxide was tried next in the research and development program. A significant issue was finding the right percentage combination of the number of sodium and potassium atoms in the solution.

The average amount of sodium and potassium minerals in a 154 pound adult man is 63 grams and 150 grams, respectively. Since the atomic weights of sodium and potassium are 23 and 39 respectively, the ratio of the number of atoms to the average normal body amounts of these minerals, is 63/23 for sodium and 150/39 for potassium. These ratios translate into 41.6% sodium atoms to 58.4% potassium atoms. However, in today's average diet, unless one is conscientiously avoiding sodium, there are more foods that contain sodium than potassium. Accordingly, the amount of sodium should be reduced somewhat.

A one and one quarter oz. bottle of the alkali buffer and minerals additives of this embodiment contains about 1200 drops. When four drops of this embodiment buffer+minerals additive is added to a 10 oz. glass of regular tap water, the water pH value increases from approximately 7 or 8 to about 9.5 to 10.5. This pH change represents approximately 10 mgs of potassium hydroxide, 3.3 mgs of sodium hydroxide, statistically reduced values of magnesium carbonate hydroxide and zinc per glass of water. The daily requirement of sodium and potassium is about 3,000 mgs and 1,000 mgs, respectively.

The purpose of this buffer is to make a drinking water whose pH value is approximately 9.5 to 10.5. This is a typical pH value of the water produced by the water ionizer when there are high amounts of minerals in the tap water. Alkaline water from an ionizer has little or no acid minerals since the ionizer removes them. High pH alkali buffer and minerals supplement for water produced by the buffer of this invention has all the acid minerals that were in the originally supplied water. If the alkali buffer and the minerals supplement were added to the alkaline water from an ionizer, it will further boost the alkalinity of that water and the water, of course, does not have acid minerals.

In some geographical areas, tap water contains very small amounts of alkaline minerals. In such cases, the pH value of the water produced by the ionizer is low, even under 8. The alkali buffer and minerals supplement of this invention helps that condition. Thus, the buffer additive of this invention is also useful as a supplement for alkaline water from an ionizer machine.

While the invention has been described with reference to a particular example of preferred embodiments, it is the intention to cover all modifications and equivalents within the scope of the following appended claims. It is therefore requested that the claims be given a liberal interpretation which is within the spirit and scope of the contribution to this art.

What is claimed is:

1. A concentrated alkali buffer+minerals supplement for alkali buffer+minerals solution that is to be added to normal drinking water in order to increase the pH value of said drinking water, and deliver essential minerals of said buffer+minerals solution comprising:
a combination of one part of active ingredients, potassium hydroxide (KOH) and sodium hydroxide (NaOH), and magnesium carbonate hydroxide (MgCO₃)₄.Mg(OH)₂.5H₂O and zinc (Zn) in combination to about nine parts USP water in order to formulate said concentrated alkali buffer+minerals supplement for blood pH balancing in the alkaline range when bicarbonate production is diminished or “endogenous acid production”(EAP)¹ is overwhelming and the body uses essential minerals from other sites where minerals consumption is normally necessary and is sacrificed to compensate for pH swings caused by EAP or other factors.

2. A alkali buffer+minerals supplement for alkali buffer solution of claim 1 wherein the potassium hydroxide (KOH) with sodium hydroxide (NaOH), with magnesium carbonate hydroxide (MgCO₃)₄.Mg(OH)₂.5H₂O and zinc (Zn) are in a range from 9.0% potassium hydroxide and 0.5% sodium hydroxide and 0.3% magnesium carbonate hydroxide and 0.2% zinc to 4.8% potassium hydroxide and 4.7% sodium hydroxide, magnesium carbonate hydroxide 0.3% and zinc 0.2%. This range is flexible to a+or minus 10% variable of the absolute values specified herein to meet certain conditions of the consumer that require this range to be altered+90% USP water; this range is flexible to allow for the production of larger volumes of the invention by volume.

3. A alkali buffer+minerals supplement for alkali buffer solution of claim 1 wherein the combination of potassium hydroxide (KOH) with sodium hydroxide (NaOH), with magnesium carbonate hydroxide (MgCO₃)₄.Mg(OH)₂.5H₂0 and zinc (Zn) are in a range consisting of from 7.6% potassium hydroxide, 1.9% sodium hydroxide, 0.3% magnesium carbonate hydroxide and 0.2% zinc to about 6.6% potassium hydroxide and 2.9% sodium hydroxide and magnesium carbonate hydroxide 0.3% and zinc at 0.2%, equaling the additives to a comprised value of 10% comprising all of the above values as additives (active ingredients) then added to 90% USP water comprising the other ingredient, the invention. This range is flexible to a+or minus 10% variable of the absolute values specified herein to meet certain conditions of the consumer that require this range to be altered+90% USP water.

4. A alkali buffer+minerals supplement additive for drinking water having a predominant alkali buffer+minerals supplement for, said drinking water comprising:
a value for the pH of the drinking water after the recommended amount of additive is added to the water then being within the alkaline range of about 9 to 10.5; and further wherein the predominant alkali buffer+minerals supplement additive contributes to the water's alkalinity is supported by the art of this invention of a alkali buffer additive which is formulated by a combination of potassium hydroxide, sodium hydroxide, magnesium carbonate hydroxide and zinc with USP water.

5. The alkali buffer+minerals supplement additive for drinking water of claim 4 wherein the combination of potassium hydroxide (KOH) with sodium hydroxide (NaOH), with magnesium carbonate hydroxide (MgCO₃)₄.Mg(OH)₂.5H₂O and zinc (Zn) said alkali additive is in a range consisting of from 9.0% potassium hydroxide, 0.5% sodium hydroxide, 0.3% magnesium carbonate hydroxide and 0.2% zinc to 4.8% potassium hydroxide and 4.7% sodium hydroxide, magnesium carbonate hydroxide 0.3% and zinc 0.2%. This range is flexible to a+or minus 10% variable of the absolute values specified here to meet certain conditions of the consumer that require this range to be altered+90% USP water

6. The alkali buffer+minerals supplement additive for drinking water of claim 4 wherein said alkali additive is formulated by a combination of potassium hydroxide (KOH) with sodium hydroxide (NaOH), with magnesium carbonate hydroxide (MgCO₃)₄.Mg(OH)₂.5H₂O and zinc (Zn) in a range consisting of from 7.6% potassium hydroxide, 1.9% sodium hydroxide, 0.3% magnesium carbonate hydroxide and 0.2% zinc to about 6.6% potassium hydroxide and 2.9% sodium hydroxide and magnesium carbonate hydroxide 0.3% and zinc at 0.2%. This range is flexible to a+or minus 10% variable of the absolute values specified here to meet certain conditions of the consumer that require this range to be altered+90% USP water.

7. The alkali buffer+minerals supplement additive for drinking water of claim 4 wherein said drinking water is ordinary tap water and said water is made into an alkaline drinking water with minerals by the addition thereto of said alkali buffer+minerals supplement consisting of potassium hydroxide, sodium hydroxide, magnesium carbonate hydroxide, and zinc in USP water.

8. The alkali buffer+minerals supplement additive for drinking water of claim 4 wherein said drinking water is an alkaline water that has been processed by an ionizer machine, and the pH of said ionizer machine water is further raised by said alkali additive to a pH value of approximately 9.5 to 0.5.

9. A method of formulating a alkali buffer+minerals supplement additive for drinking water, comprising the steps of:
adjusting a pH value for the drinking water to about 9 to 0.5;
supplying said pH value by homogeneous mixing a predominant alkali buffer+minerals supplement for drinking water in the form of an additive which is formulated by combining potassium hydroxide (KOH) with sodium hydroxide (NaOH), with magnesium carbonate hydroxide (MgCO₃)₄.Mg(OH)₂.5H₂O and and zinc (Zn) mixed together and added to USP water forming a alkali buffer+minerals supplement additive.

10. The method of claim 9 wherein the combining step is further characterized by:
selecting the amounts of said potassium hydroxide (KOH) with sodium hydroxide (NaOH), with magnesium carbonate hydroxide (MgCO₃)₄.Mg(OH)₂.5H₂0 and zinc (Zn) in said additive to fall within a range consisting of from 9.0% potassium hydroxide, 0.5% sodium hydroxide, 0.3% magnesium carbonate hydroxide, 0.2% zinc to 4.8% potassium hydroxide and 4.7% sodium hydroxide, magnesium carbonate hydroxide 0.3% and zinc 0.2%. This range is flexible to a+or minus 10% variable of the absolute values specified here to meet certain conditions of the consumer that require this range to be altered+90% USP water

11. The method of claim 9 wherein the combining step is further characterized by:
selecting the amounts of said potassium hydroxide (KOH) with sodium hydroxide (NaOH), with magnesium carbonate hydroxide (MgCO₃)₄.Mg(OH)₂.5H₂0 and zinc (Zn) to fall within a range consisting of from about from 7.6% potassium hydroxide, 1.9% sodium hydroxide, 0.3% magnesium carbonate hydroxide and 0.2% zinc to about 6.6% potassium hydroxide and 2.9% sodium hydroxide and 0.3% magnesium carbonate hydroxide and 0.2% zinc. This range is flexible to a+or minus 10% variable of the absolute values specified here to meet certain conditions of the consumer that require this range to be altered+90% USP water.

12. The method of claim 9 and further characterized by the steps of:
drawing an amount of ordinary tap water;
converting said ordinary tap water into an alkaline water and minerals supplement to drinking water to achieve alkaline water having said pH value 9.5 to 10.5 by adding 4 drops to an 8 to 10 oz. glass of water.

13. The method of claim 1 further characterized by the step of:
bottling die alkali buffer+minerals supplement additive concentrate into a non-reactive bottle made of such material that will prevent any foreign agents from leaching into the concentrate that is the subject of this invention.
